(19) United States
(12) Patent Application Publication
(10) Pub. No.: US 2026/0119148 A1
(43) Pub. Date: Apr. 30, 2026

(54) MANAGEMENT OF DEPLOYMENTS USING FEDERATED LEARNING

(71) Applicant: Dell Products L.P., Round Rock, TX (US)

(72) Inventors: MUZHAR S. KHOKHAR, Shrewsbury, MA (US); RAJINI RAMACHANDRAN KARTHIK, Austin, TX (US); ANDREA ROGGERONE, Dublin (IE); VINAY SAWAL, Fremont, CA (US); BRIAN ROCHFORD, Cork (IE)

(21) Appl. No.: 18/928,709

(22) Filed: Oct. 28, 2024

(51) Int. Cl. G06F 8/65

(52) U.S. Cl. CPC G06F 8/65

(57) ABSTRACT

Methods and systems for managing operation of a plurality of deployments of data processing systems are disclosed. The operation may be managed by generating at least one update, based at least one relationship between data of at least one data processing system and/or at least one extraction model of the at least one data processing system. The at least one relationship may be transmitted to a management system and ingested by at least one global extraction model of the management system to generate at least one global relationship. The at least one global relationship may be evaluated using on a management policy. Based on the evaluation, the at least one data processing system may be updated to improve a provision of computer implemented services.

### FIELD

Embodiments disclosed herein relate generally to managing operation of a plurality of deployments of data processing systems. More particularly, embodiments disclosed herein relate to updating the operation of the data processing systems using relationships based on data from the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show data flow diagrams illustrating operation of a system in accordance with an embodiment.

FIGS. 3A-3B show flow diagrams illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting.

Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing operation of a plurality of deployments of data processing systems. The operation may be managed by performing at least one update to at least one data processing system of the data processing systems. The at least one update may be performed by obtaining at least one management decision from a management system.

The at least one management decision may be obtained by (i) receiving, from the at least one data processing system, at least one relationship between data of the at least one data processing system and at least one model output of at least one extraction model of the at least one data processing system, (ii) obtaining, using the at least one relationship, at least one aggregate relationship, (iii) obtaining, using the at least one aggregate relationship and at least one global extraction model, at least one global relationship, and (iv) evaluating the at least one global relationship using a management policy of the plurality of the deployments.

The data of the at least one data processing system may be subject to at least one administrative regulation so the at least one relationship, rather than the data, may be transmitted to the management system. The aggregate relationship may be obtained by computing a weighted sum using the at least one relationship. The at least one global relationship may be obtained by computing a second weighted sum using the at least one aggregate relationship. The global relationship may be evaluated by performing, using the at least one global relationship, an assessment of performance of the plurality of deployments.

From the evaluation using the management policy, at least one update may be generated. The at least one update and at least the global relationship may be transmitted to the at least one data processing system. A weight, bias, gradient, etc. of the at least one extraction model may be modified to generate a second at least one extraction model. The second extraction model may generate a second at least one model output. Between the data of the at least one data processing system and the second at least one model output, a second at least one relationship may be obtained that matches the at least one global relationship. In addition, the at least one data processing system may be updated using the at least one update to improve a provision of computer implemented services.

In an embodiment, a method for managing operation of a plurality of deployments of data processing systems is disclosed. The method may include: (i) obtaining, by a management system and from the plurality of the deployments, a plurality of relationships based on operation data that is based on operation of the data processing systems, the operation data comprising at least a portion of information subject to administrative regulations, and the plurality of the relationships not being subject to the administrative regulations, (ii) obtaining, by the management system, aggregate relationships for the plurality of the deployments based on the plurality of relationships, (iii) obtaining, by the management system and using an ensemble modeling process, global relationships for the plurality of the deployments, (iv) obtaining, by the management system and using at least the global relationships, management decisions for the data processing systems, (v) updating, by the management system using the management decisions, operation of the data processing systems to obtain an updated plurality of the deployments and (vi) providing computer implemented services using the updated plurality of deployments.

At least one of the plurality of the relationships may be based on a local extraction model exclusively maintained and used by one of the plurality of deployment, each of the plurality of deployments maintaining a separate local extraction model.

The method may further include updating, by the management system, the local extraction model based on the global relationships.

The aggregate relationships may be a weighted sum.

The global relationships may be obtained using a global model exclusively maintained and used by the management system.

The operation data may include personally identifiable information.

The plurality of relationships may be derived, at least in part, from the operation data using an irreversible derivation process.

The operation data may include telemetry data.

Updating the operation of the data processing systems may include at least selected from a list of updating consisting of (i) changing a security posture of at least one of the data processing systems, (ii) modifying a configuration of at least one of the data processing systems, and (iii) changing a software loadout of at least one of the data processing systems.

The plurality of relationships may be based, at least in part, on graph data structures representing the plurality of deployments.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

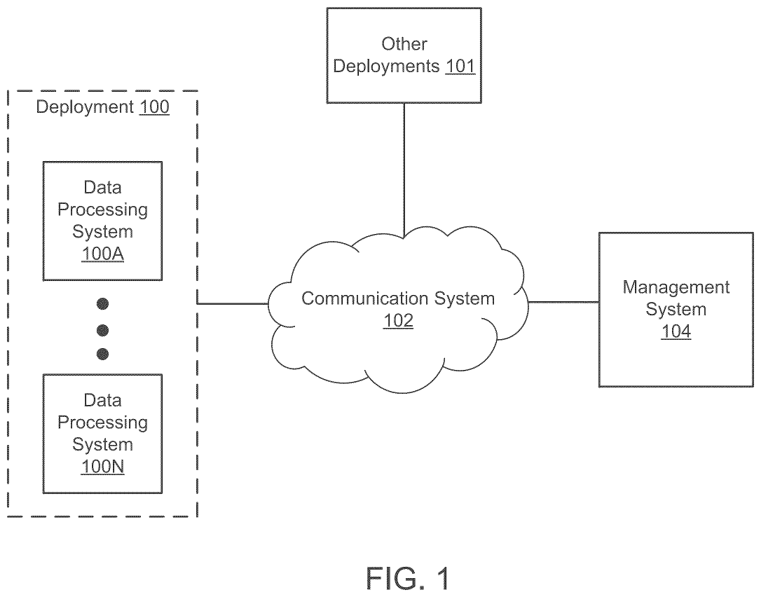

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, data processing systems may be configured. The data processing systems may be configured by, for example, updating at least one configuration setting in a setting file, user interface, application programing interface (API), etc. The at least one configuration setting may be a parameter for at least one process relating to data ingestion, data transformation, resource allocation, and/or security policies. By updating the at least one configuration setting, the at least one process may be improved.

However, if the at least one process is not configured, then the at least one configuration setting may not be updated. If the at least one configuration setting is not updated, then computer implemented services may not be provided.

In general, embodiments disclosed here relate to systems and methods for managing operation of a plurality of deployments of data processing systems. The operation may be managed by improving the second operation of at least one local extraction model of at least one data processing system of the data processing systems. The at least one local extraction model may be trained using siloed data. The siloed data may include telemetry data, the use and dissemination of which is subject to at least one administrative regulation. The telemetry data may include personally identifiable information, internet protocol (IP) addresses, user activities, etc. The at least one local extraction model may be trained by (i) ingesting the siloed data, (ii) modifying at least one weight, bias, gradient, etc. of the local extraction model based on the siloed data, and (iii) generating at least one model output.

Because of the at least one administrative regulation, ingestion of the siloed data by a second local extraction model may result in an administrative violation. The siloed data, being stored in a first locality, may be export-controlled from dissemination to a second locality, where the second local extraction model is located. However, rather than disseminating the siloed data, at least one relationship between at least pattern and/or at least one trend of the siloed data and at least one model output of the local extraction model may be disseminated.

Examples of the at least one relationship may include (i) a pattern of network traffic and/or usage alongside the model output of expected latency and/or response time, (ii) the pattern of memory, computer processing unit (CPU), and/or disk usage alongside the model output of scaling parameters for the memory, the CPU, and/or the disk usage, and (iii) the pattern of log and/or error messages alongside alerts and/or predictions on potential system failures. The at least one relationship may be illustrated using at least one graph structure. The at least one graph structure may illustrate the pattern of the siloed data and/or the model output using at least one node and/or the at least one relationship between the pattern and/or the model output using an edge.

The at least one relationship may be transmitted to a management system. The management system, using the at least one relationship, may obtain an at least one aggregate relationship. The at least one aggregate relationship may be obtained by combining the at least one relationship into the at least one aggregate relationship. The at least one aggregate relationship may be combined using a weighted sum. The weighted sum may include a sum of at least one product, the at least one product including the at least one relationship and a weight for the at least one relationship.

At least one global relationship, using the at least one aggregate relationship, may be generated. The at least one global relationship may be generated by ingesting the at least one aggregate relationship in an ensemble modeling process by the management system. The ensemble modeling process may include using at least one global extraction model, a type of model such as (i) a graph neural network, (ii) a Bayesian network, (iii) reinforcement learning, (iv) relational machine learning, etc. The at least one global extraction model may be used to make at least one prediction. The at least one prediction may be ingested in a second weighted sum. The second weighted sum may be a second sum of a second at least one product, the second at least one product including the at least one prediction and a weight for the at least one prediction. The second weighted sum may yield at least one global relationship.

Using on the at least one global relationship, at least one management decision may be generated by the management system. The at least one management decision may be generated by (i) ingesting the at least one global relationship in a management policy and (ii) deriving at least one actionable step to be taken by the at least one local extraction model.

The at least one actionable step may include performing an update to the operation of the deployment. The update may include at least one correction to at least one weight, bias, gradient, etc. of the local extraction model. The at least one correction may enable the at least one local extraction model to generate a second at least one model output is similar to a third at least one model output of a global extraction model. With the second at least one model output being similar to the third at least one model output, the at least one relationship may be obtained that matches the at least one global relationship. Further, the update may include a modification to at least one operation of at least one data processing system of the deployment.

To provide the above noted functionality, the system may include deployment 100, other deployments 101, and management system 104. Each of these components is discussed below.

Deployment 100 may include any number of data processing system 100A-100N. Other deployments 101 may also include the any number of data processing systems similar to data processing system 100A-100N. The any number of data processing system 100A-100N may perform at least one operation to provide computer implemented services. The at least one operation may be performed according to at least one configuration setting. The at least one configuration setting may be performed based on at least one update from a management system (e.g., 104).

For the update to be performed by the management system (e.g., 104), at least one local extraction model may generate at least one model output. The at least one local extraction model may generate at least one model output by ingesting siloed data and applying at least one weight, bias, gradient, etc. to a mathematical operation that includes the siloed data. The local extraction model may include (i) a neural network, (ii) support vector machines, (iii) a decision tree, etc.

Using the at least one model output, at least one relationship may be generated. The at least one relationship may be a correlation between the at least model output and a pattern and/or trend of the siloed data. Examples of the at least one relationship may include (i) a pattern of network traffic and/or usage alongside the model output of expected latency and/or response time, (ii) the pattern of memory, computer processing unit (CPU), and/or disk usage alongside model output of scaling parameters for the memory, the CPU, and/or the disk usage, and (iii) the pattern of log and/or error messages alongside alerts and/or predictions on potential system failures. The at least one relationship may be illustrated using at least one graph structure. The at least one graph structure may illustrate the pattern and/or trend and/or the at least one model output using at least one node and the at least one relationship between the pattern and/or the trend and/or the model using an edge.

The at least one relationship may be transmitted to management system 104. The management system (e.g., 104) may generate at least one global relationship. The management system (e.g., 104) may generate the at least one global relationship by (i) obtaining at least one aggregate relationship, (ii) ingesting, by an ensemble modeling process, the at least one aggregate relationship to generate at least one prediction, (iii) transforming the at least one prediction into the at least one global relationship, and (iv) obtaining, using the at least one global relationship, a management decision to improve the provision of the computer implemented services.

The at least one aggregate relationship may be obtained by computing a weighted sum of the at least one relationship received from the any number of data processing system 100A-100N and at least one weight of the at least one relationship. The at least one prediction may be transformed into the at least one global relationship by computing a second weighted sum using the at least one prediction and at second at least one weight of the prediction. Finally, a management decision may be obtained by evaluating the at least one global relationship based on at least one management policy to generate the management decision.

The at least one global relationship and/or the management decision may be transmitted to the any number of data processing system 100A-100N from the management system (e.g., 104). The at least one global relationship may be used to update at least one weight, bias, gradient, etc. in the at least one local extraction model of the any number of data processing system 100A-100N. The update may be performed on the at least one local extraction model to correct the at least one model output. With the correction to the at least one local extraction model, a second at least one model output may be obtained from the local extraction model and can be used, for example though iterating at least one generation of at least one prediction, to generate a second at least one relationship that matches the at least global relationship. Also, the at least one management decision may be used to update the at least one configuration setting to improve a provision of the computer implemented services.

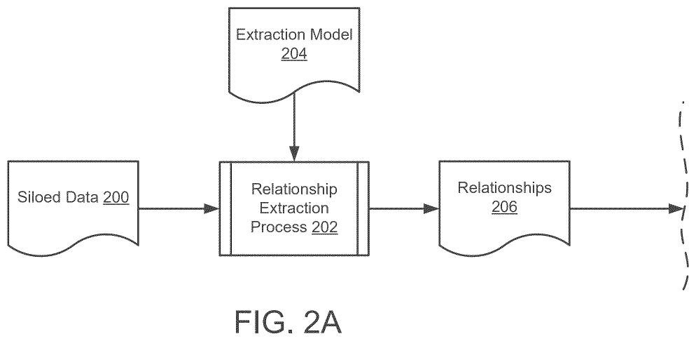

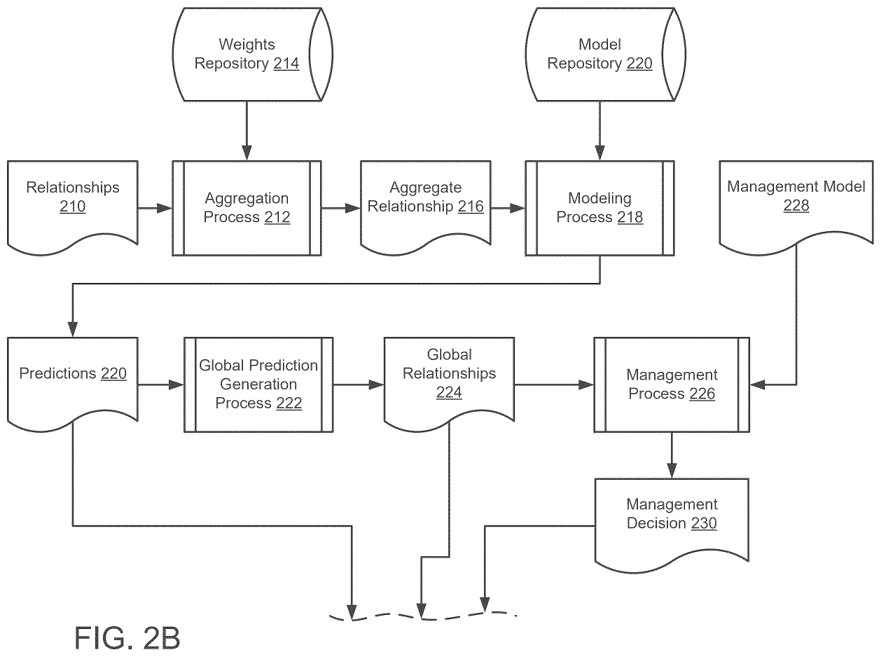

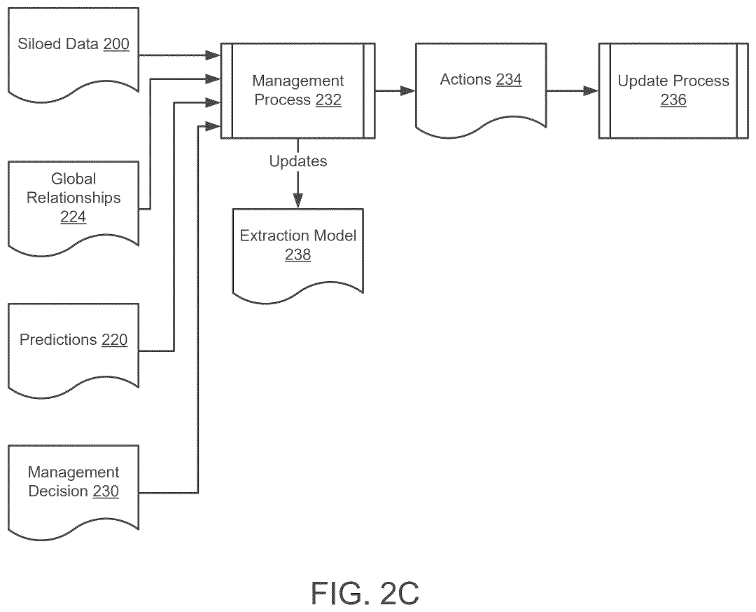

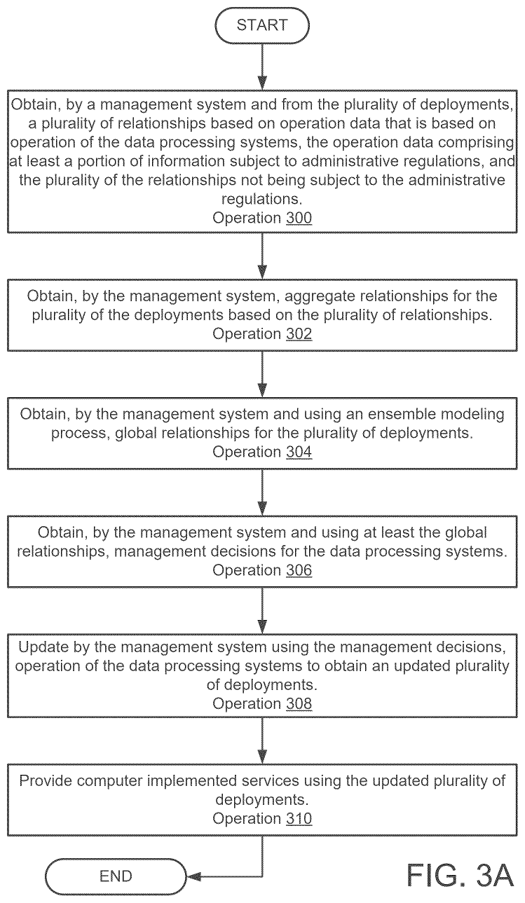

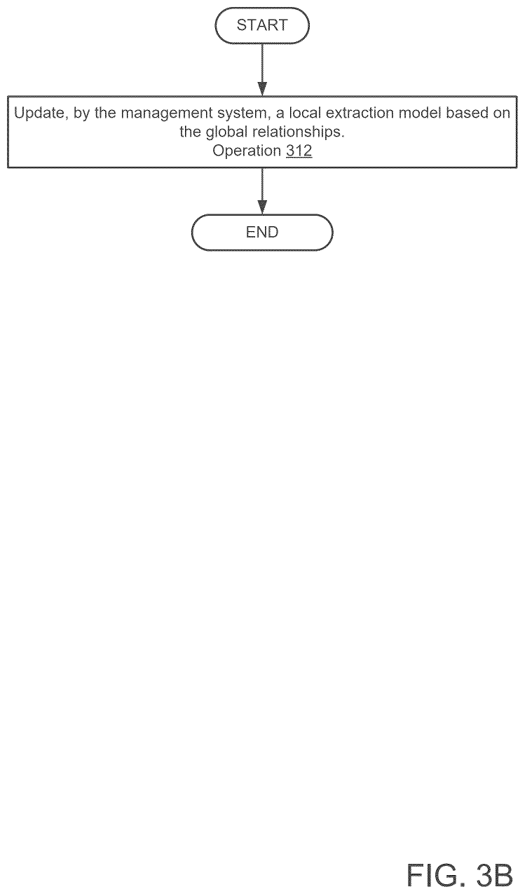

While providing their functionality, any of deployment 100 and management system 104 may perform all, or a portion, of the flows and methods shown in FIGS. 2A-3B.

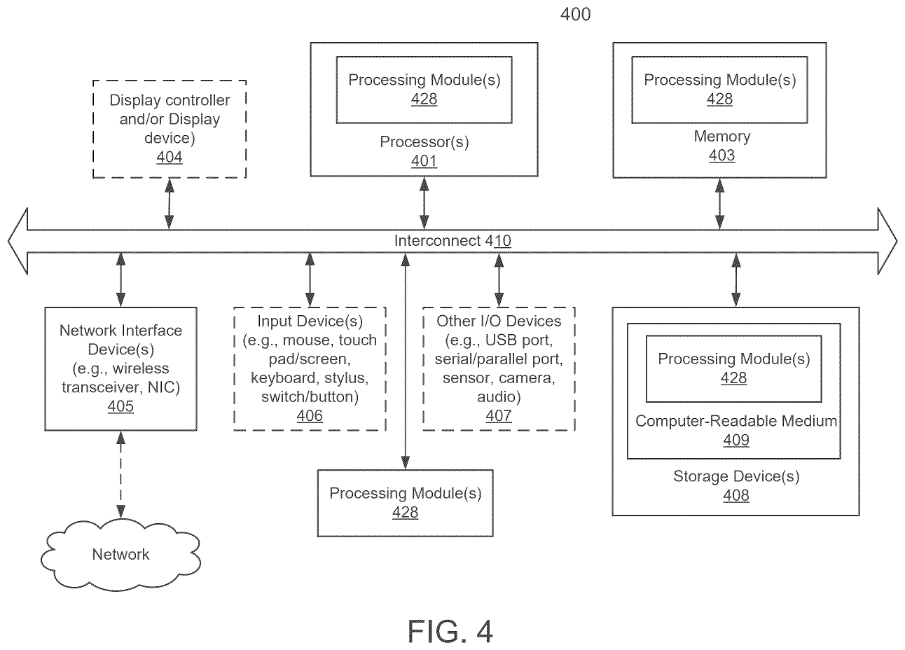

Any of (and/or components thereof) deployment 100 and management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 206, etc.) is used to represent data structures, a second set of shapes (e.g., 202, 212, etc.) is used to represent processes performed using and/or that generate data, and a third set of shapes (e.g., 214, 220, etc.) is used to represent large scale data structures such as databases.

Turning to FIG. 2A, a first data flow diagram in accordance with an embodiment is shown. The first data flow diagram may illustrate data used in and data processing performed in obtaining at least one relationship.

To obtain the at least one relationship, relationship extraction process 202 may be performed. During relationship extraction process 202, siloed data (e.g., 200) and an extraction model (e.g., 204) may be ingested.

The siloed data (e.g., 200) may include data that is stored on at least one data processing system (e.g., 100A). The siloed data (e.g., 200) may include telemetry data. The telemetry data may include personally identifiable information, internet protocol (IP) addresses, user activities, etc. The siloed data (e.g., 200) may be export-controlled from dissemination. For example, the siloed data (e.g., 200) may be stored in at least one data processing system (e.g., 100A) in a first locality. Because the siloed data (e.g., 200) is export-controlled, transmission of the siloed data (e.g., 200) to at least another data processing system (e.g., 100B) in a second locality may violate at least one administrative regulation.

The siloed data (e.g., 200) may be ingested by an extraction model (e.g., 204). The extraction model (e.g., 204) may be a trained inference model. The trained inference model may include (i) a neural network, (ii) support vector machines, (iii) a decision tree, etc. The extraction model (e.g., 204) may ingest the siloed data (e.g., 200) and apply at least one weight, bias, gradient, etc. to a mathematical operation that includes the siloed data (e.g., 200) to generate at least one model output. The at least one model output may include at least one recommendation, based on the siloed data (e.g., 200), to update a data processing system.

Examples of the at least one model output may include (i) a recommended CPU and/or memory capacity based on CPU and/or memory usages, (ii) a recommended scaling to error mechanisms based on a frequency and/or type of errors that occur on a regular basis, (iii) a recommended automation to at least one task based on at least one observation of user activity patterns.

During relationship extraction process 202, at least one relationship may be obtained based on at least one correlation on at least one pattern in the siloed data (e.g., 200) and the at least one model output. The at least one correlation may be established using, for example, a correlation analysis, clustering, and/or sensitivity testing. The correlation analysis may include computing at least one correlation coefficient between data of the siloed data (e.g., 200) and the at least one model output. The clustering may include grouping similar at least one similar data value of the siloed data (e.g., 200) and observing the at least one model output for each grouping. The sensitivity testing may include varying of at least one characteristic of the data of the siloed data (e.g., 200) and observing at least one change in the at least one model output.

As a result of relationship extraction process 202, relationships (e.g., 206) may be generated. The relationships (e.g., 206) may include at least one correlation between at least one pattern and/or at least one trend in the siloed data (e.g., 200) and the at least one model output. The relationships (e.g., 206) may not include data of the siloed data (e.g., 200). The at least one correlation may be illustrated using at least one graph structure. The at least one graph structure may illustrate may the at least one pattern and/or the at least one trend and/or the model output using at least one node and the at least one relationship between the at least one pattern and/or the at least one trend and/or the model using an edge.

The at least one data processing system (e.g., 100A) may transmit the relationships (e.g., 206) to a management system (e.g., 104). The transmission may occur through a communication system (e.g., 102) though, for example, a data stream, a network connection, etc.

Thus, via the interaction illustrated in FIG. 2A, a system in accordance with an embodiment may in obtaining at least one relationship of the relationships (e.g., 206).

Consequently, a deployment (e.g., 100) may be more likely to be able to provide desired computer implemented services by determining the at least one correlation between at least one pattern and/or one trend and at least one model output and/or sending the at least one relationship without sending the data.

Turning to FIG. 2B, a second data flow diagram in accordance with an embodiment is shown. The second data flow diagram may illustrate data used in and data processing performed in obtaining an update for at least one data processing system (e.g., 100A) from a management system (e.g. 104).

To obtain the update, aggregation process 212 may be performed. During aggregation process 212, relationships (e.g., 210) may be ingested. While a second relationships (e.g., 206), from FIG. 2A, includes at least one relationship from at least one data processing system (e.g., 100A), the relationships (e.g., 210) may include at least one relationship from a second at least one data processing system (e.g., 100B).

In addition to ingesting the relationships (e.g., 210), during aggregation process 212, a weights repository (e.g., 214) may be queried. The weights repository (e.g., 214) may be queried during aggregation process 212 for at least one weight. The at least one weight may be associated with the at least one relationship of the relationships (e.g., 210).

During aggregation process 212, the at least one weight from the weights repository (e.g., 214) and the at least one relationship from the relationships (e.g., 210) may be used in a weighted sum. The weighted sum may include a sum of at least one product of the at least one relationship and a weight of the at least one relationship. An aggregate relationship (e.g., 216) may include the weighted sum.

The aggregate relationship (e.g., 216) may be ingested into modeling process 218. During modeling process 218, at least one global extraction model may be selected from a model repository (e.g., 220). The at least one global extraction model may include a model type such as (i) a graph neural network, (ii) a Bayesian network, (iii) reinforcement learning, (iv) relational machine learning, etc. For each of the type of mode, the model repository (e.g., 218) may include the at least one global extraction model with at least one set of weight, bias, gradient, etc.

During modeling process 218, the at least one global extraction model may be selected based on (i) accuracy, (ii) efficiency, (iii) scalability, (iv) suitability to the at least one relationship, etc. For each of the at least one global extraction model, at least one prediction may be generated. The at least one prediction may be generated by applying at least set of one weight, bias, gradient, etc. to a mathematical operation that includes the at least one relationship to generate the at least one prediction.

The predictions (e.g., 220) may include the at least one prediction. The at least one prediction may be generated by the at least one global extraction model. To determine a global relationship using the at least one prediction, global prediction generation process 222 may be performed.

During global prediction generation process 222, at least one global relationship may be obtained by ingesting the at least one relationship. The at least one global relationship may be obtained by computing a second weighted sum. The second weighted sum may include a sum of at least one product, the at least one product including the at least one prediction and a second at least weight of the at least one prediction. Computation of the second weighted sum may yield the at least one global relationship. Global relationships (e.g. 224) may include the at least one global relationship.

Using the at least one global relationship of the global relationships (e.g., 224), management process 226 may be performed. During management process 226, a management model (e.g., 228) may be ingested. The management model (e.g., 228) may include at least one policy. The at least one policy may include at least one set of guidelines for (i) data processing, (ii) data security, (iii) performance monitoring, (iv) compliance, etc.

During management process 226, an evaluation may take place using the at least one global relationship of the global relationships (e.g., 224). The evaluation may take place by comparing the at least one global relationship to at least one guideline of the management policy. For example, the at least one global relationship may include a relationship that demonstrates that CPU usage among users of the at least data processing system (e.g., 100A) increases to 80% in the afternoon for at least one undetermined reason. To continue a provision of computer implemented services, evaluation by the management model (e.g., 228) may demonstrate that resources (e.g., power, etc.) may need to be diverted from at least one process to a second at least one process used by the users.

Therefore, a management decision (e.g., 230) may be obtained during management process 226. The management decision (e.g., 230) may include (i) reducing the power and/or shutting down the at least one process and (ii) increasing the power and resources for the second at least one process to enable the provision of the computer implemented services to the users during the afternoon. As a result of management process 230, the management decision (e.g., 230) may be obtained.

The management decision (e.g., 230), the global relationships (e.g., 224), and/or the predictions (e.g., 220) may be transmitted to the at least one data processing system (e.g., 100A). The transmission may occur through a communication system (e.g., 102) using, for example, a data stream, a network connection, etc.

Thus, via the interaction illustrated in FIG. 2B, a system in accordance with an embodiment may obtain an update for at least one data processing system (e.g., 100A) from the management system (e.g. 104). Consequently, a deployment (e.g., 100) may be more likely to be able to provide desired computer implemented services by using the at least one relationship from the at least one data processing system (e.g., 100A, etc.) to obtain the update and the at least one global relationship for the at least one data processing system (e.g., 100A, etc.).

Turning to FIG. 2C, a third data flow diagram in accordance with an embodiment is shown. The third data flow diagram may illustrate data used in and data processing performed in performing at least one update on at least one data processing system (e.g., 100A).

To perform the at least one update, management process 232 may be performed. During management process 232, the global relationships (e.g., 224), the predictions (e.g., 220), and/or the management decision (e.g., 230) may be received from a management system (e.g., 104) by the at least one data processing system (e.g., 100A) and ingested by management process 232. Further, the siloed data (e.g., 200) may be ingested by management process 232.

During management process 232, the at least one update may be performed on the extraction model (e.g., 204). The at least one update may be performed by ingesting the siloed data (e.g., 200), by extraction model (e.g., 204), to generate at least one model output. At least one pattern and/or at least one trend from the siloed data (e.g., 200) may be correlated with the at least one model output to generate at least one relationship. The at least one relationship may not match at least one global relationship of the global relationships (e.g., 224). However, at least one weight, bias, gradient, etc. of the extraction model (e.g., 204) may be modified and a second at least one model output may be generated by the extraction model (e.g., 204). A second at least one pattern and/or at least one trend from the siloed data (e.g., 200) may be correlated with the second at least one model output to generate a second at least one relationship. The second at least one relationship may not match the at least one global relationship of the global relationships (e.g., 224) but may include a closer match compared to the at least one relationship.

A procedure described in the previous paragraph may be repeated until (i) a final at least one relationship matches the at least one global relationship of the global relationships (e.g., 224) and (ii) a final at least one model output matches at least one prediction of predictions 220. In the procedure, the at least one weight, bias, gradient, etc. of the extraction model (e.g., 204) may be modified to yield the final at least one model output and therefore yield a final at least one pattern and/or a final at least one trend that is included in the final at least one relationship. As a result of the procedure, a second extraction model (e.g., 238) may be obtained.

In addition to updating the extraction model (e.g., 204) to the second extraction model (e.g., 238), during management process 230, an actionable step (e.g., 234) may be obtained using a management decision from the management system (e.g., 104). The actionable step (e.g., 204) may be obtained by (i) identifying at least one parameter of the at least one data processing system (e.g., 100A) affected by the management decision (e.g., 230) and (ii) performing the at least one update to the at least one parameter to meet at least one criterium that is mandated by the management decision (e.g., 230).

The at least one parameter may be identified by performing a search, by the at least one data processing system, for at least one component and/or at least one process identified in the management decision (e.g., 230). Once the at least one component and/or the at least one process has been identified, then the at least one update may be performed. The at least one update may be performed by modifying the at least one parameter so that the at least one criterium is met by the at least one data processing system (e.g., 100A). The modification of the at least one parameter may be the actionable step (e.g., 234).

For example, the management decision (e.g., 230) may include, to enable provision of computer implemented services for all users in the afternoon (i) reducing the power and/or shutting down the at least one process and (ii) increasing the second power and the resources for the second at least one process to enable the provision of the computer implemented services to the users. The power may be reduced and/or shut down for the at least one process and/or the second power and/or the resources may be increased for the second at least one process by generating, by the at least one data processing system (e.g., 100A), a new time-based process. The new time-based process may include new source code that may regulate the at least one process and/or the second at least one process. The new time-based process may be activated, during the afternoon, to (i) scale down the power for the at least one process and (ii) scale up the second power and/or allocate more of the resources for the second at least one process. Since the new time-based process runs in the afternoon, the new time-based process may be deactivated, by the at least one data processing system, when the afternoon elapses.

To include, by the at least one data processing system (e.g., 100A), the actionable step (e.g., 234), update process 236 may be performed. During update process 236, the at least one data processing system (e.g., 100A) may be updated so that the at least one component and/or the at least one process generates the action specified by the actionable item. The at least one data processing system (e.g., 100A) may be updated by (i) generating, by an administrator and/or an inference mode, new code for the at least one component and/or the at least one process, and/or (ii) utilizing the new code so that a modification to the at least one component and/or the at least one process takes effect.

In addition, during update process 236, the at least one data processing system (e.g., 100A) may be updated by (i) changing a security posture of at the at least one data processing system (e.g., 100A) and/or (ii) changing a software loadout of at the at least one data processing system (e.g., 100A). The security posture may be changed by modifying the at least one component and/or the at least one process of a security protocol for the at least one data processing system (e.g., 100A). The software loadout may be changed by including new software and/or deactivating current software for the provision of the computer implemented services by the at least one data processing system (e.g., 100A).

Thus, via the interaction illustrated in FIG. 2C, a system in accordance with an embodiment may update at least one data processing system (e.g., 100A). Consequently, a deployment (e.g., 100) may be more likely to be able to provide desired computer implemented services by modifying, based on a decision from the management system (e.g., 104) and by the at least one data processing system (e.g., 100A), the at least one component and/or the at least one process of the at least one data processing system (e.g., 100A) to provide desired computer implemented services.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage operation of a plurality of deployments of data processing systems. FIG. 3A illustrates a method that may be performed by the components of the system of FIG. 1. In the diagram discussed below and shown in FIG. 3A, any of the operations may be repeated, performed in different orders, and/or performed in parallel with or in a partially overlapping in time manner with other operations.

Turning to FIG. 3A, a flow diagram illustrating a method of managing operation of a plurality of deployments of data processing systems in accordance with an embodiment is shown. The method may be performed, for example, by any of the components of the system of FIG. 1, and/or other components not shown therein.

At operation 300, a plurality of relationships may be obtained, by a management system (e.g., 104) and from the plurality of deployments (e.g., 100, 101, etc.), based on operation data that is based on operation of the data processing systems (e.g., 100A, 100B, etc.), the operation data comprising at least a portion of information subject to administrative regulations, and the plurality of the relationships not being subject to the administrative regulations. The plurality of the relationships may be obtained by obtaining at least one relationship between the operational data and at least one model output. The model output may be generated by ingesting, by a local extraction model of an at least one data processing system (e.g., 100A), the operational data and generating the at least one model output.

At operation 302, aggregate relationships may be obtained, by the management system, for the plurality of deployment based on the plurality of relationships. The aggregate relationships may be obtained by ingesting, by the management system (e.g., 104), the at least one relationship from the at least one data processing system (e.g., 100A). The management system may compute a weighted sum, the weighted sum including at least one product, the at least one product including a product of the at least one relationship and a weight of the at least one relationship.

At operation 304, global relationships for the plurality of deployments may be obtained by the management system and using an ensemble modeling process. The global relationships may be obtained by computing a second weighted sum. The second weighted sum may include a second at least one product, the second at least one product including a product of at least one prediction by at least one global extraction model and a weight of the at least one global extraction model. The at least one global extraction model may ingest an aggregate relationship of the aggregate relationships to generate the at least one prediction.

At operation 306, management decisions for the data processing systems may be obtained by the management system and using at least the global relationships. The management decisions may be obtained by performing an evaluation of the global relationships based on at least one management policy to obtain the management decisions. The management decisions may be transmitted to the at least one data processing system (e.g., 100A).

At operation 308, operation of the data processing systems may be updated by the management system using the management decisions to obtain to obtain an updated plurality of deployments. The operation may be updated by (i) changing a security posture of at least one of the data processing systems (e.g., 100A), (ii) modifying a configuration of at least one of the data processing systems (e.g., 100A), and/or (iii) changing a software loadout of at least one of the data processing systems (e.g., 100A).

The security posture of the at least one of the data processing systems (e.g., 100A) may be changed by modifying the at least one component and/or the at least one process of a security protocol for the at least one data processing system (e.g., 100A). The configuration of the at least one of the data processing systems (e.g., 100A) may be modified by generating, by an administrator and/or an inference mode, new code for the at least one component and/or the at least one process, and/or (ii) utilizing the new code so that a modification to the at least one component and/or the at least one process takes effect. The software loadout of the at least one of the data processing systems (e.g., 100A) may be changed by including new software and/or deactivating current software for the provision of the computer implemented services by the at least one data processing system (e.g., 100A).

At operation 310, the computer implemented services may be provided using the updated plurality of the deployments. The computer implemented services may be provided by performing, by the updated plurality of the deployments, of at least one operation that utilizes the at least one component and/or the at least one process.

The method may end following operation 310.

Thus, via the method shown in FIG. 3A, embodiments herein may likely improve a likelihood of managing operation of a plurality of deployments of data processing systems. By improving the likelihood of managing operation of a plurality of deployments of data processing systems, the data processing systems may be more likely to provide desirable computer implemented services by, for example, transmitting the at least one relationship between the operational data and the at least one model output to the management system (e.g., 104), using the at least one relationship to generate the management decisions by which to update the operation of the plurality of the deployments, etc.

As discussed above, the components of FIG. 1 may perform various methods to manage operation of a plurality of deployments of data processing systems. FIG. 3B illustrates a method that may be performed by the components of the system of FIG. 1. In the diagram discussed below and shown in FIG. 3B, any of the operations may be repeated, performed in different orders, and/or performed in parallel with or in a partially overlapping in time manner with other operations.

Turning to FIG. 3B, a flow diagram illustrating a method of managing operation of a plurality of deployments of data processing systems in accordance with an embodiment is shown. The method may be performed, for example, by any of the components of the system of FIG. 1, and/or other components not shown therein.

At operation 312, a local extraction model may be updated, by the management system, based on the global relationships. The local extraction model may be updated by adjusting at least one weight, bias, gradient, etc. As a result, at least one relationship, based on a model output by the local extraction model, after the at least one weight, bias, gradient, etc. has been adjusted, may match at least one global relationship of the global relationships.

Thus, via the method shown in FIG. 3B, embodiments herein may likely improve a likelihood of managing operation of a plurality of deployments of data processing systems. By improving the likelihood of managing operation of a plurality of deployments of data processing systems, the data processing systems may be more likely to provide desirable computer implemented services by, for example, ensuring that the local extraction model yields at least one relationship similar to an at least one global relationship that has been obtained using a global extraction model from a management system (e.g., 104), etc.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a plurality of deployments of data processing systems, the method comprising:
obtaining, by a management system and from the plurality of the deployments, a plurality of relationships based on operation data that is based on operation of the data processing systems, the operation data comprising at least a portion of information subject to administrative regulations, and the plurality of the relationships not being subject to the administrative regulations;
obtaining, by the management system, aggregate relationships for the plurality of the deployments based on the plurality of relationships;
obtaining, by the management system and using an ensemble modeling process, global relationships for the plurality of the deployments;
obtaining, by the management system and using at least the global relationships, management decisions for the data processing systems;
updating, by the management system using the management decisions, operation of the data processing systems to obtain an updated plurality of the deployments; and
providing computer implemented services using the updated plurality of deployments.

2. The method of claim 1, wherein at least one of the plurality of the relationships is based on a local extraction model exclusively maintained and used by one of the plurality of the deployments, each of the plurality of deployments maintaining a separate local extraction model.

3. The method of claim 2, further comprising:
updating, by the management system, the local extraction model based on the global relationships.

4. The method of claim 1, wherein the aggregate relationships are a weighted sum.

5. The method of claim 1, wherein the global relationships are obtained using a global model exclusively maintained and used by the management system.

6. The method of claim 1, wherein the operation data comprises personally identifiable information.

7. The method of claim 1, wherein the plurality of relationships are derived, at least in part, from the operation data using an irreversible derivation process.

8. The method of claim 1, wherein the operation data comprises telemetry data.

9. The method of claim 1, wherein updating the operation of the data processing systems comprises at least selected from a list of updating consisting of:
changing a security posture of at least one of the data processing systems;
modifying a configuration of at least one of the data processing systems; and
changing a software loadout of at least one of the data processing systems.

10. The method of claim 1, wherein the plurality of relationships are based, at least in part, on graph data structures representing the plurality of deployments.

11. A non-transitory machine-readable medium having instructions stored therein, which when executed by a processor, cause the processor to perform operations for managing operation of a plurality of deployments of data processing systems, the operations comprising:
obtaining, by a management system and from the plurality of the deployments, a plurality of relationships based on operation data that is based on operation of the data processing systems, the operation data comprising at least a portion of information subject to administrative regulations, and the plurality of the relationships not being subject to the administrative regulations;
obtaining, by the management system, aggregate relationships for the plurality of the deployments based on the plurality of relationships;
obtaining, by the management system and using an ensemble modeling process, global relationships for the plurality of the deployments;
obtaining, by the management system and using at least the global relationships, management decisions for the data processing systems;
updating, by the management system using the management decisions, operation of the data processing systems to obtain an updated plurality of the deployments; and
providing computer implemented services using the updated plurality of deployments.

12. The non-transitory machine-readable medium of claim 11, wherein at least one of the plurality of the relationships is based on a local extraction model exclusively maintained and used by one of the plurality of the deployments, each of the plurality of deployments maintaining a separate local extraction model.

13. The non-transitory machine-readable medium of claim 12, wherein the operations further comprise:
updating, by the management system, the local extraction model based on the global relationships.

14. The non-transitory machine-readable medium of claim 11, wherein the aggregate relationships are a weighted sum.

15. The non-transitory machine-readable medium of claim 11, wherein the global relationships are obtained using a global model exclusively maintained and used by the management system.

16. A data processing system, comprising:
a processor; and
a memory coupled to the processor to store instructions, which when executed by the processor, cause the processor to perform operations managing operation of a plurality of deployments of data processing systems, the operations comprising:
obtaining, by a management system and from the plurality of the deployments, a plurality of relationships based on operation data that is based on operation of the data processing systems, the operation data comprising at least a portion of information subject to administrative regulations, and the plurality of the relationships not being subject to the administrative regulations;
obtaining, by the management system, aggregate relationships for the plurality of the deployments based on the plurality of relationships;
obtaining, by the management system and using an ensemble modeling process, global relationships for the plurality of the deployments;
obtaining, by the management system and using at least the global relationships, management decisions for the data processing systems;
updating, by the management system using the management decisions, the operation of the data processing systems to obtain an updated plurality of the deployments; and
providing computer implemented services using the updated plurality of deployments.

17. The data processing system of claim 16, wherein at least one of the plurality of the relationships is based on a local extraction model exclusively maintained and used by one of the plurality of the deployments, each of the plurality of deployments maintaining a separate local extraction model.

18. The data processing system of claim 17, wherein the operations further comprise:
updating, by the management system, the local extraction model based on the global relationships.

19. The data processing system of claim 16, wherein the aggregate relationships are a weighted sum.

20. The data processing system of claim 16, wherein the global relationships are obtained using a global model exclusively maintained and used by the management system.
